(19) United States
(12) Patent Application Publication
(10) Pub. No.: US 2004/0193468 A1
(43) Pub. Date: Sep. 30, 2004

(54) System for optimizing business rule resources

(76) Inventors: Dave Mosquera, West Chicago, IL (US); Anthony Dezonno, Bloomingdale, IL (US); Michael Sheridan, Oak Park, IL (US); Jeff Hodson, Wheaton, IL (US); Carlo Bonifazi, Woodridge, IL (US)

Correspondence Address: WELSH & KATZ, LTD, 120 S RIVERSIDE PLAZA, 22ND FLOOR, CHICAGO, IL, 60606, US

(21) Appl. No.: 10/403,583

(22) Filed: Mar. 31, 2003

(51) Int. Cl. G06F 17/60

(52) U.S. Cl. 705/8

(57) ABSTRACT

A method and apparatus are provided for allocating a plurality of resources among call types in a call center operated by a business organization. The method includes the steps of providing a plurality of business rules for allocating call handling resources to the call types of the business organization and measuring a metric among the call types for determining a compliance with each business rule of the plurality of business rules. The method further includes the steps of comparing the measured metrics of the plurality of business rules with respective threshold values and adjusting the plurality of resources among the call types when a compared metric of the compared metrics exceeds a respective threshold of the thresholds.

### FIELD OF THE INVENTION

The field of the invention relates to contact centers and more particularly to methods of assigning contact center agents to calls.

### BACKGROUND OF THE INVENTION

The use of contact centers by organizations for call delivery to its agents is generally known. Contact centers are generally understood to have been evolved from call centers. A call center is a call processing system that processes calls through a public switched telephone network (PSTN). The term “contact center” is generally understood to involve calls arriving through the PSTN and also through other communication mediums (e.g., the Internet).

Contact centers are differentiated from telephone and Internet message delivery systems in general by the contact center's ability to automatically deliver calls to any one of a number of agents of the organization based upon some algorithm used by the contact center. Features such as DNIS and ANI within the PSTN may be used to determine an intended call target and an identity of the caller. Similar features may be used with regard to messages sent through the Internet.

By knowing the call target of the caller, the contact center may select an agent who is best suited to handle the subject matter of the call. Further, by knowing an identity of the caller, a host attached to the contact center may retrieve customer records that may be displayed on a terminal of the agent at the instant the call is delivered to the agent.

In order to effectively serve a customer base, agents are often grouped by training into call groups. Often the size of the groups for any particular work shift is based upon experience and an expected workload.

While existing methods of operating contact centers are relatively effective, contact centers are often subject to wide variations in call arrival rates. Further, the variations are often disproportionate among the various call types creating situations where one agent group is overloaded while another group remains idle.

In order to deal with the variability in call arrival rate, many contact centers provide a supervisor to monitor for the presence of and to control such disparities. When noticed, the supervisor may re-assign agents as needed to equalize any load imbalance. While such methods are effective, a supervisor's intervention may not be entirely effective in meeting organizational objectives. Accordingly, a need exists for a better method of allocating resources within a contact center.

### SUMMARY

A method and apparatus are provided for allocating a plurality of resources among call types in a call center operated by a business organization. The method includes the steps of providing a plurality of business rules for allocating call handling resources to the call types of the business organization and measuring a metric among the call types for determining a compliance with each business rule of the plurality of business rules. The method further includes the steps of comparing the measured metrics of the plurality of business rules with respective threshold values and adjusting the plurality of resources among the call types when a compared metric of the compared metrics exceeds a respective threshold of the thresholds.

### BRIEF DESCRIPTION OF THE DRAWINGS

FIG. 1 is a block diagram of a contact center in accordance with an illustrated embodiment of the invention; and

FIG. 2 is a block diagram of a resource processor that may be used by the system of FIG. 1.

### DETAILED DESCRIPTION OF AN ILLUSTRATED EMBODIMENT

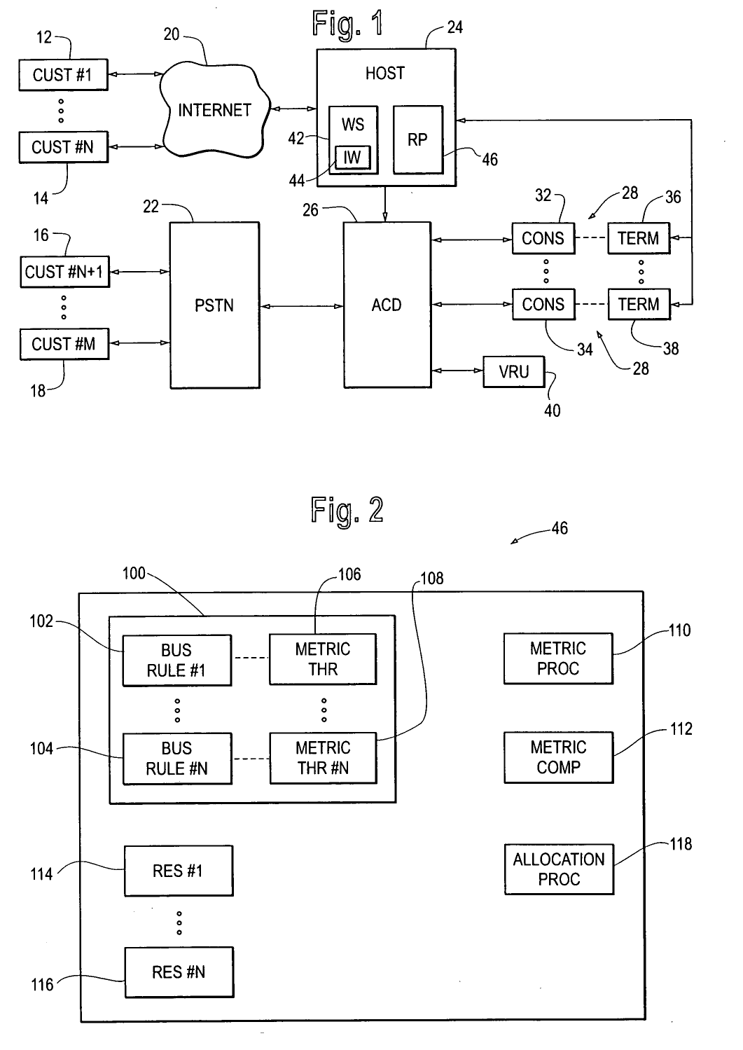

FIG. 1 is a block diagram of a contact center 10 shown under an illustrated embodiment of the invention. The contact center 10 described and shown herein operates under the control of a comprehensive set of business rules that generally control resource allocation to call types within the call center. Typically, the business rules are prioritized to allow the more important rules to prevail when there is a conflict among the rules.

A metric may be measured among the call types to determine a compliance with each business rule of the set of business rules. As used herein, measuring a metric among the call types means identifying one or more metrics for measuring compliance with each business rule and selecting each call type, one at a time for measurement of the one or more metric. The measured metrics may then be compared among the call types to determine which call type fared the best under each business rule. Resources may then be allocated pro rata among the call types based upon the priority of the business rule.

The business rules described herein relate to the business of the organization using the call center. As such, the business rules are directly related to the business objectives of the organization and only tangentially related to call processing. In this regard, the business rule(s) having the highest level of priority is (are) always related to recognized business objectives (e.g., greatest profit per call, least cost per call, etc.) rather than to contact center objectives (e.g., average speed of answer (ASA), abandonment rate, etc.).

That being said, it should also be understood that in some cases, conventional call center objectives (i.e., ASA) could also be business objectives). For example, it is known that the Federal Communication Commission (FCC) requires that cable companies answer calls within a predetermined time interval after call arrival (e.g., within 20 seconds). In this case, a maximum ASA of 20 seconds may also be a primary business objective of the organization in certain special circumstances.

It should also be recognized that once the primary business objectives of the organization are satisfied, conventional call center objectives may also become business objectives. This would be understood to be true because, in most cases, without providing good customer service, there could be no certainty that an organization's primary business objectives would ever be reached. As such, conventional call center objectives (e.g., minimizing ASA, minimizing abandonment rate, minimizing average talk time, etc.) may also be regarded as lower priority business objectives.

The contact center 10 may include an automatic call distributor (ACD) 26 and host 24. The ACD 26 may function to process conventional calls with customers 16, 18 through the PSTN 22. The host 24 may process Internet calls with customers 12, 14 through the Internet 24.

The ACD 26 of the contact center 10 may process incoming and outgoing calls and connect them with an appropriate agent working at an agent station 28, 30. Each agent station 28, 30 may include a telephone console 32, 34 for handling conventional telephone calls through the PSTN 22 and a computer terminal 36, 38 for handling Internet calls delivered through the host 24.

While two agent stations 28, 30 are shown in FIG. 1, it should be understood that any number of agents 28, 30 may be used by the system 10. It should also be understood that the agents 28, 30 may be evaluated based upon call handling skills and grouped accordingly. Grouping may be based upon one or more skills associated with specific call types.

With regard to processing incoming or outgoing calls, the contact center 10 may operate conventionally. In the case of incoming calls, the ACD 26 may receive DNIS and ANI information along with the arriving calls. In the case of outgoing calls, the host 24 may transfer telephone numbers of customers 16, 18 to the ACD 26. Upon receiving the telephone numbers, the ACD 26 may place a call to the customer 16, 18 through the PSTN 22.

In either case, the ACD 26 may open a call file and save any call associated information (e.g., DNIS, ANI, called number, etc.) in the file. From the DNIS information, the ACD 26 may determine a call destination (i.e., a call type) of the call. In the case of an outgoing call, the host 24 may transfer an identifier of a purpose of the call to the ACD 26. In either case, the host 24 or ACD 26 may select an agent 28, 30 based upon the destination or purpose of the call and connect the call to an agent 28, 30 accordingly.

The ACD 26 may also transfer an identifier of the selected agent and identifier of the customer 16, 18 to the host 24. The host 24, in turn, may deliver any customer records to the terminal 36, 38 at the same instant that the call is delivered to the console 32, 34 of the agent 28, 30.

Similarly, the host 24 may maintain a website 42 for the benefit of clients of the organization using the contact center 10. Within particular webpages of the website 42, a CONTACT AGENT softkey may be provided to allow a customer 12, 14 to engage in an e-mail or chat session with an agent 28, 30. Alternatively, the host 24 may maintain a list of IP addresses of customers and download advertising messages with a CONTACT AGENT softkey to customers 12, 14.

In either case, the host 24 may function to set up Internet calls with agents 28, 30 based upon the call type (e.g., the webpage from which the CONTACT AGENT softkey was activated, based upon the message downloaded to the customer 12, 14, etc.). Based upon the subject matter of the webpage or message, either the host 24 or ACD 26 may select an agent 28, 30 to handle the call. Upon selecting a qualified agent 28, 30, the host 24 may download the subject matter of the call and IP address of the customer 12, 14 to the agent terminal. 36, 38. The agent 28, 30 may, in turn, initiate contact with the customer 12, 14 or the host 24 may instruct the terminal 36, 38 to initiate the contact automatically.

In order to service customers 12, 14, 16, 18, the organization may separate the agents 28, 30 into call groups and may assign each group to a particular call type. For example, if the organization is a department store, then one group of agents 28, 30 may handle hardware and another group may handle calls about ladies shoes. A still further group may handle calls through the Internet directed to the same or different subject matter.

One or more voice response units (VRU) 40 may be provided to further service customers 16, 18. The VRU 40 may function to collect information from customers 16, 18 to further determine a call type, to reduce the customer/agent interaction time and to further improve the call handling capacity of the contact center 10.

Similarly, in the case of the website 42, one or more interactive windows 44 may be provided to collect customer preferences and interests regarding activation of a CONTACT AGENT softkey. The interactive windows 44 may be used as a resource to improve the call handling capacity of the contact center 10 by collecting preliminary information from the customer 12, 14 to further define the call type thereby reducing the transaction time of the agent 28, 30.

In general, any call-handling resource of the contact center 10 (e.g., agents 28, 30, VRUs 40, interactive windows 44, etc.) may be assigned and re-assigned based upon the business rules of the organization and upon the volume and content of arriving calls. The initial assignment of agents 28, 30 to a work shift may be based upon a supervisor's estimate of agents needed or upon the use of software force management packages. Once a work shift has begun, a resource controller 46 (FIG. 2) within the host 24 may reallocate resources to customer needs as necessary.

Included within the resource processor 46 may be a memory 100 containing a set of business rules 102, 104. In order to measure adherence to each business rules, one or more metrics may be measured and compared to an appropriate standard (e.g., threshold values 106, 108). If the metric(s) meets/does not meet the standard, then call resources may be allocated as appropriate to the business rule.

For example, in some types of organizations, maximization of profit may define the primary (i.e., highest priority) business rule. It may be assumed that, in most cases, the primary business rule would be selected and satisfied first. After the primary business rule has been satisfied, other secondary, lesser priority business rules may be selected and satisfied. However, as described below, the selection process is relatively fluid and may incorporate the processes of secondary business rules to help define the processes necessary to satisfy the primary business rule.

In this example, the measured metric would be the profit per call for each call type. The profit may be determined on the net profit of any product sold during a transaction, or, more preferably, the profit may be the average profit for each minute of agent talk time.

The use of average profit for each minute of agent talk time allows the organization to automatically adjust its resources where for some reason (e.g., a product promotion, consumer preferences, etc.) a product becomes “hot”. Such a process would allow the resource controller 46 to look at two agent groups that have an equal call loading and recognize that one agent group (assigned to a first call type) is generating more profit than another agent group (assigned to a second call type). In the case where the contact center 10 is fully loaded, recognition of the higher profit of one call type over another would allow the organization to focus its limited resources on the call type generating the most profit instead of democratically distributing its resources to all call types.

In this example, secondary business rules 104 may be directed to conventional contact center parameters (e.g., abandonment rate, average time in queue, etc.). The consideration of conventional contact center parameters in the secondary business rule context allows the contact center 10 to treat all calls equally during periods of light loading and to shift resources to the most important calls (as defined by the primary business rule(s)) during resource-limited time periods.

To continue the example, a metric processor 110 may sequentially select each call type (agent group) and calculate the average profit based upon talk time. A metric comparator 112 may be used to compare the average profit of each agent group. As the agent group providing the greatest average profit is identified, an identifier of that group (i.e., the call type) and a value of the greatest average profit may be stored as a threshold value 106 associated with the highest priority business rule 102. As customer preferences change during succeeding time periods (e.g., minutes, hours, weeks, etc.), the threshold value 106 may also change and/or the resource processor 46 may replace the first call type with other call types.

As the calculated metric of the primary business rule changes, the resource controller 46 may compare the calculated metric with the threshold value to adjust the resources among the call types when the compared metric exceeds the threshold. As used herein adjusting the resources among the call types means reassigning agents among groups (i.e., call types) or adding other resources (e.g., VRUs 40, unassigned agents, etc.) to the call type.

Once the highest profit call type has been identified, an allocation processor 118 within the resource processor 46 may use a number of strategies to allocate resources to the call type. For example, a secondary metric 106 of the primary business rule or a secondary business rule 104 may specify a threshold value 108 for a maximum average speed of answer (ASA) for a call of the highest profit call type. If the ASA exceeds that threshold 108, the allocation processor 118 may add more resources.

One resource that may be added is one or more VRUs 40. The use of a VRU 40 may reduce agent time by collecting information in advance of an agent's connection to the call.

Another resource may be agents 28, 30 that had been previously assigned to other call groups. In this regard, the agents 28, 30 may have been previously given a skill rating in each call type and a value of each agent's skill may have been stored as a resource metric 114, 116 for each agent 28, 30.

In order to select additional resources for the highest profit call type, the metric processor 110 and metric comparator 112 may be used to order the agents 28, 30 in descending order based upon a value factor (e.g., their skill in handling the calls of the highest profit type, their ability to generate profit, the number of calls of the highest profit type that the agent can process per time period, etc.). As used herein, an available agent is an agent that has not already been assigned to the call type of the business rule being considered (in this example, the primary business rule). The resource processor 46 may continue to assign additional agents 28, 30 to the highest profit call type in descending order until such time as the ASA falls below the threshold 108.

Alternatively, the second (or lesser priority) business rule 104 may also specify a minimum value factor (e.g., threshold skill level) of any agent 28, 30 assigned to the highest profit call type. In this case, the resource controller 46 may only assign a limited number of agents 28, 30 to the most profitable call type. Other lower level business rules may control resource allocation among the remaining call types after the primary business rule has been satisfied.

In another example, the organization (e.g., a political organization, an environmental organization, etc.) may not be interested in profits and may, in fact, have another focus. In this case, the organization using the contact center 10 may have a primary business rule that is directed to minimizing costs per call. In this case, the contact center 10 may not have rigid groups, but may allow each agent to handle a certain number of each type of call. As each type of call is handled, the metric processor 110 may time the call and determine a cost per call and call type. As the metric processor 110 determines an average cost per call, the processor 110 saves the data as a resource metric 114, 116.

As calls are processed by the contact center 10, one of the secondary business rules 104 may be to minimize the average speed of answer (ASA). A maximum threshold 108 may be provided for that purpose. However, the primary business rule 102 may also limit the number of calls that an agent may be assigned for a particular call type based upon their average cost per call for that call type.

Accordingly, an interaction exists between the highest priority business rule 102 and the secondary business rule 104. In this case, the metric processor 110 and comparator 112 may be used to order the resource metrics 114, 116 for each call type in ascending order of cost per call for each call type. As the ASA for any particular call type rises, the metric processor 110 may attempt to add agents from the ordered list. To add an agent, the metric processor 110 may use the metric comparator 112 to compare the resource metric 114, 116 of each agent with the metric threshold 106 of the primary business rule. If the agent's resource metric 114, 116 does not exceed the maximum average cost per call, the agent may be added to the group for a particular call type. If the agent exceeds the threshold 106, then the agent would not be added.

A specific embodiment of a method and apparatus for optimizing business rule resources has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of allocating a plurality of resources among call types in a call center operated by a business organization, such method comprising the steps of:
providing a plurality of business rules for allocating call handling resources to the call types of the business organization;
measuring a metric among the call types for determining a compliance with each business rule of the plurality of business rules;
comparing the measured metrics of the plurality of business rules with respective threshold values; and
adjusting the plurality of resources among the call types when a compared metric of the compared metrics exceeds a respective threshold of the thresholds.

2. The method of allocating a plurality of resources for handling calls as in claim 1 further comprising prioritizing the plurality of business rules.

3. The method of allocating a plurality of resources for handling calls as in claim 2 further comprising ordering the plurality of resources based upon a value factor for each business rule of the plurality of business rules.

4. The method of allocating a plurality of resources for handling calls as in claim 3 further comprising selecting a business rule of the prioritized plurality of business rules with a highest relative priority as a primary business rule.

5. The method of allocating a plurality of resources for handling calls as in claim 4 further comprising comparing a value of the metric of the selected business rule with a threshold value for the metric of the selected business rule and adding a resource of the plurality of resources to a call type of the selected business rule when the metric exceeds the threshold value.

6. The method of allocating a plurality of resources for handling calls as in claim 5 wherein the step of adding the resource further comprises assigning an available resource of the ordered resources with a highest relative value factor for the selected business rule.

7. The method of allocating a plurality of resources for handling calls as in claim 5 further comprising selecting a business rule of the prioritized plurality of business rules with a lesser relative priority as the selected business rule when the metric of the business rule with the greatest relative priority does not exceed the threshold.

8. The method of allocating a plurality of resources for handling calls as in claim 7 further comprising comparing a value of the metric of the selected lesser priority business rule with a threshold value and adding a resource of the plurality of resources to handle a call type under the selected lesser priority business rule when the metric of the lesser priority business rule exceeds the threshold value.

9. The method of allocating a plurality of resources for handling calls as in claim 8 wherein the step of adding the resource further comprises assigning an available resource of the ordered resources with a highest relative value factor for the selected business rule.

10. The method of allocating a plurality of resources for handling calls as in claim 1 wherein the identified metric further comprises profit per call.

11. The method of allocating a plurality of resources for handling calls as in claim 1 wherein the identified metric further comprises cost per call.

12. An apparatus for allocating a plurality of resources among call types in a call center operated by a business organization, such apparatus comprising:
a plurality of business rules for allocating call handling resources to the call types of the business organization;
means for measuring a metric among the call types for determining a compliance with each business rule of the plurality of business rules;
means for comparing the measured metrics of the plurality of business rules with respective threshold values; and
means for adjusting the plurality of resources among the call types when a compared metric of the compared metrics exceeds a respective threshold of the thresholds.

13. The apparatus for allocating a plurality of resources for handling calls as in claim 12 further comprising means for prioritizing the plurality of business rules.

14. The apparatus for allocating a plurality of resources for handling calls as in claim 13 further comprising means for ordering the plurality of resources based upon a value factor for each business rule of the plurality of business rules.

15. The apparatus for allocating a plurality of resources for handling calls as in claim 14 further comprising means for selecting a business rule of the prioritized plurality of business rules with a highest relative priority as a primary business rule.

16. The apparatus for allocating a plurality of resources for handling calls as in claim 15 further comprising means for comparing a value of the metric of the selected business rule with a threshold value for the metric of the selected business rule and adding a resource of the plurality of resources to a call type of the selected business rule when the metric exceeds the threshold value.

17. The apparatus for allocating a plurality of resources for handling calls as in claim 16 wherein the means for adding the resource further comprises means for assigning an available resource of the ordered resources with a highest relative value factor for the selected business rule.

18. The apparatus for allocating a plurality of resources for handling calls as in claim 16 further comprising means for selecting a business rule of the prioritized plurality of business rules with a lesser relative priority as the selected business rule when the metric of the business rule with the greatest relative priority does not exceed the threshold.

19. The apparatus for allocating a plurality of resources for handling calls as in claim 18 further comprising means for comparing a value of the metric of the selected lesser priority business rule with a threshold value and adding a resource of the plurality of resources to handle a call type under the selected lesser priority business rule when the metric of the lesser priority business rule exceeds the threshold value.

20. The apparatus for allocating a plurality of resources for handling calls as in claim 19 wherein the means for adding the resource further comprises means for assigning an available resource of the ordered resources with a highest relative value factor for the selected business rule.

21. The apparatus for allocating a plurality of resources for handling calls as in claim 12 wherein the identified metric further comprises profit per call.

22. The apparatus for allocating a plurality of resources for handling calls as in claim 12 wherein the identified metric further comprises cost per call.

23. An apparatus for allocating a plurality of resources among call types in a call center operated by a business organization, such apparatus comprising:
a plurality of business rules for allocating call handling resources to the call types of the business organization;
a metric processor adapted to measure a metric among the call types for determining a compliance with each business rule of the plurality of business rules;
a metric comparator adapted to compare the measured metrics of the plurality of business rules with respective threshold values; and
an allocation processor adapted to adjust the plurality of resources among the call types when a compared metric of the compared metrics exceeds a respective threshold of the thresholds.

24. A method of allocating a plurality of resources for handling calls in a call center operated by a business organization, such method comprising the steps of:
providing a plurality of business rules for handling calls and call types of the business organization;
identifying a metric for measuring compliance with each of the plurality of business rules;
determining a change in the identified metric of each of the plurality of business rules provided by each resource of the plurality of resources; and
allocating the plurality of resources to calls based upon the plurality of business rules and the determined change in the identified metric provided by the respective resources for at least some of the plurality of business rules.

25. A method of allocating resources in a call center operated by a business organization, such method comprising the steps of:
allocating a plurality of resources under a first business rule of the business organization; and
re-allocating at least some of the plurality of resources based upon a second business rule of the organization.

26. A method of allocating resources in a call center operated by a business organization, such method comprising the steps of:
providing a plurality of business rules for allocating a plurality of resources to calls within the call center;
identifying at least some resources of the plurality of resources that are associated with each business rule; and
balancing the plurality of resources among a plurality of calls based upon the plurality of business rules.

27. A method of allocating resources in a call center operated by a business organization, such method comprising the steps of:
allocating a plurality of resources under a first business rule of the business organization; and
re-allocating at least some of the plurality of resources based upon a second business rule of the organization.

28. A method of allocating resources in a call center operated by a business organization, such method comprising the steps of:
providing a plurality of business rules for allocating a plurality of resources to calls within the call center;
identifying at least some resources of the plurality of resources that are associated with each business rules; and
balancing the plurality of resources among a plurality of calls based upon the plurality of business rules.
